(19) United States
(12) Patent Application Publication
(10) Pub. No.: US 2007/0084076 A1
(43) Pub. Date: Apr. 19, 2007

(54) Wheeled distance measuring device

(76) Inventor: Hui Chen Wang, Taichung (TW)

Correspondence Address: CHARLES E. BAXLEY, ESQ., 90 JOHN STREET, THIRD FLOOR, NEW YORK, NY, 10038, US

(21) Appl. No.: 11/250,839

(22) Filed: Oct. 14, 2005

(51) Int. Cl. G01B 3/12

(52) U.S. Cl. 33/772

(57) ABSTRACT

A wheeled distance measuring device includes a wheel rotatably attached to a housing, a casing secured to the housing and having a protrusion to form an anchoring shoulder, and a stand having a shaft rotatably attached to the casing and having an anchoring edge for engaging with the protrusion of the casing and for positioning the stand to the casing at a downward working position. The casing includes a spring-biased latch extendible out to selectively engage with the stand, and to further position the stand to the casing at the downward working position. The casing includes an actuator biased to engage with a cam member of the stand, for selectively positioning the stand to the casing.

### BACKGROUND OF THE INVENTION

1. Field of the Invention

The present invention relates to a distance measuring device, and more particularly to a wheeled distance measuring device having a stand or kickstand that may be stably anchored or positioned thereto and that may be prevented from falling down inadvertently.

2. Description of the Prior Art

Typical distance measuring devices comprise a flexible reel tape pullable or movable out of a housing, for distance measuring purposes. The flexible tape is required to be wound and received into the housing after the distance measuring operations.

The other typical distance measuring devices comprise a counter or distance meter attached to a wheel axle of a measuring wheel, and rotated or driven by the wheel axle of the wheel, for distance measuring purposes, and for forming or acting as a wheeled distance measuring device.

The wheels of such typical wheeled distance measuring devices are rotatable and may not be stably positioned in place, and may be moved or rotated relative to the typical wheeled distance measuring devices, particularly after the predetermined location or position has been measured.

For positioning and maintaining the typical wheeled distance measuring devices in the upright position, particularly after the distance measuring operation, the typical wheeled distance measuring devices may further include a kickstand attached thereto, to support and to position or to maintain the typical wheeled distance measuring devices in the upright position.

For example, U.S. Pat. No. 6,892,470 to Olson et al. discloses one of the typical distance measuring devices comprising a U-shaped stand attached thereto. However, in use, the wheel has to .be elevated and moved away from the ground by the stand, such that the distance measuring operation may be incorrect when the wheel is moved away from the ground.

The present invention has arisen to mitigate and/or obviate the afore-described disadvantages of the conventional wheeled distance measuring devices.

### SUMMARY OF THE INVENTION

The primary objective of the present invention is to provide a wheeled distance measuring device including a stand or kickstand that may be stably anchored or positioned thereto and that may be prevented from falling down inadvertently.

In accordance with one aspect of the invention, there is provided a wheeled distance measuring device comprising a housing, a wheel rotatably attached to the housing for distance measuring purposes, a casing secured to the housing, and including a protrusion extended therefrom, to form an anchoring shoulder therein, and a stand including a shaft rotatably attached to the casing, and including an anchoring edge for engaging with the protrusion of the casing and for positioning the stand to the casing at a downward working position.

The casing includes a spring-biased latch received therein and extendible out therefrom, to selectively engage with the stand, and to further position the stand to the casing at the downward working position.

The latch includes at least one catch extended therefrom, for engaging into an interior of the casing, and for engaging with the casing, to limit a sliding movement of the latch relative to the casing, and to prevent the latch from being disengaged from the casing.

The casing includes a spring member disposed therein and engaged with the latch, for biasing and forcing the latch to move out of the casing and to engage with the stand. The casing includes a pin extended therein and engaged with the spring member, for stably positioning the spring member in the casing.

The casing includes a channel formed therein for rotatably receiving the shaft of the stand, and for rotatably attaching the stand to the casing.

The casing includes an actuator biased to engage with the shaft of the stand, for selectively maintaining and positioning the stand to the casing at the downward working position. The stand includes a cam member provided on the shaft thereof, for engaging with the actuator.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is a perspective view of a wheeled distance measuring device in accordance with the present invention;

FIG. 2 is a partial exploded view of the wheeled distance measuring device;

FIG. 3 is a perspective view illustrating a casing of the wheeled distance measuring device;

FIG. 4 is a bottom perspective view of the casing of the wheeled distance measuring device;

FIG. 5 is a partial side view of the wheeled distance measuring device, in which a portion of the casing has been cut off for showing an inner structure of the wheeled distance measuring device;

FIG. 6 is a front view of the wheeled distance measuring device;

FIG. 7 is a front view similar to FIG. 6, illustrating the operation of the stand of the wheeled distance measuring device; and

FIGS. 8, 9 are enlarged partial cross sectional views of the wheeled distance measuring device as shown in FIGS. 6 and 7 respectively.

### DETAILED DESCRIPTION OF THE PREFERRED EMBODIMENT

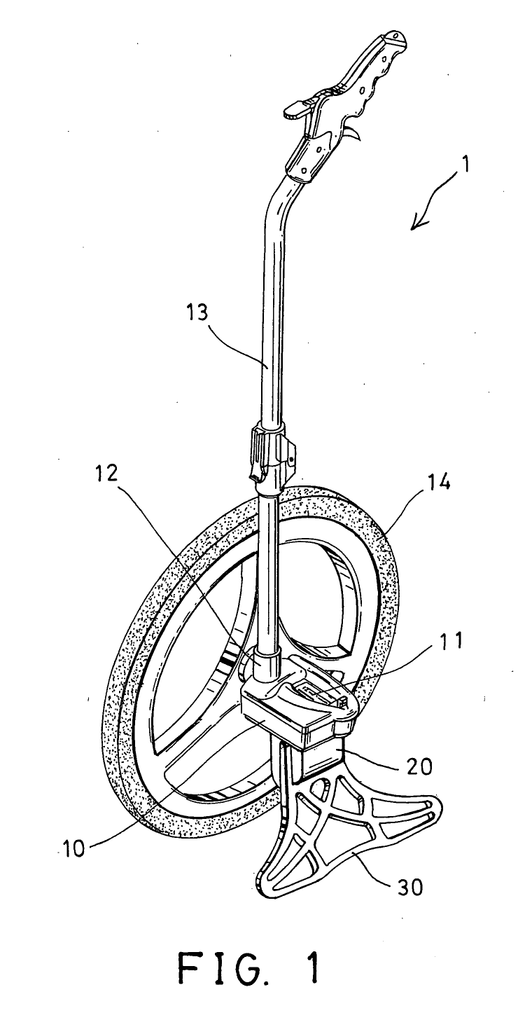

Referring to the drawings, and initially to FIGS. 1-2, and 6-7, a wheeled distance measuring device 1 in accordance with the present invention comprises a housing 10 including a typical counter or distance meter 11 attached or disposed therein and including a hub 12 extended upwardly therefrom, for coupling to a longitudinal pole or handle 13, and a wheel 14, such as a measuring wheel 14 including a wheel axle 15 rotatably engaged or attached to the housing 10 and including a typical gearing device (not shown) for distance measuring purposes. The longitudinal handle 13 may include a telescopic structure, for being retracted or folded to a compact folding structure. The above-described structure is typical and will not be discussed in further details.

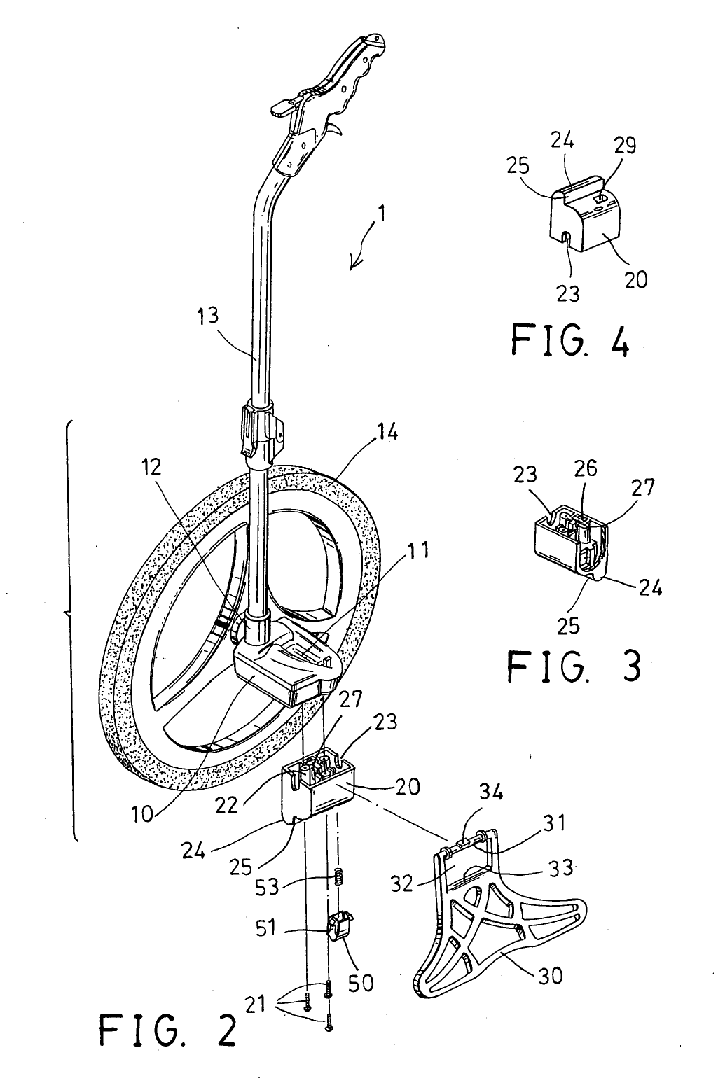

A casing 20 may be secured to the bottom of the housing 10 with such as fasteners 21 (FIGS. 2, 8-9), for example, the casing 20 may include one or more studs 22 formed or provided therein for receiving the fasteners 21, and for allowing the fasteners 21 to secure the casing 20 to the bottom of the housing 10. The casing 20 includes a lateral channel 23 formed or provided in the upper portion thereof for rotatably receiving a pivot shaft 31 of a stand 30, and for rotatably or pivotally attaching or securing the stand 30 to the casing 20 and thus to the housing 10. The stand 30 includes an opening 32 formed therein and defined by or between the shaft 31 and an anchoring edge 33.

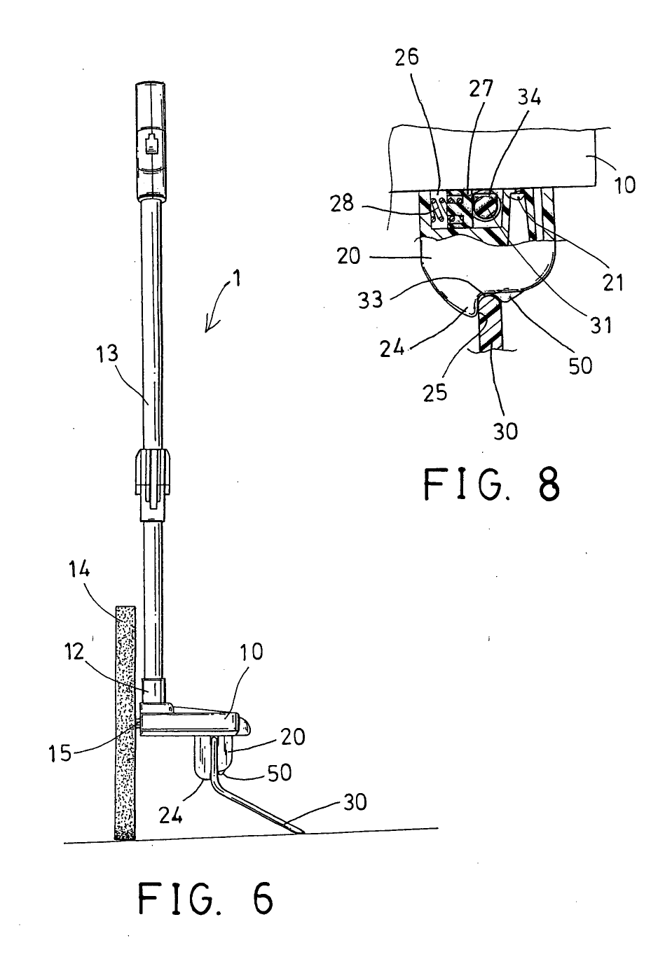

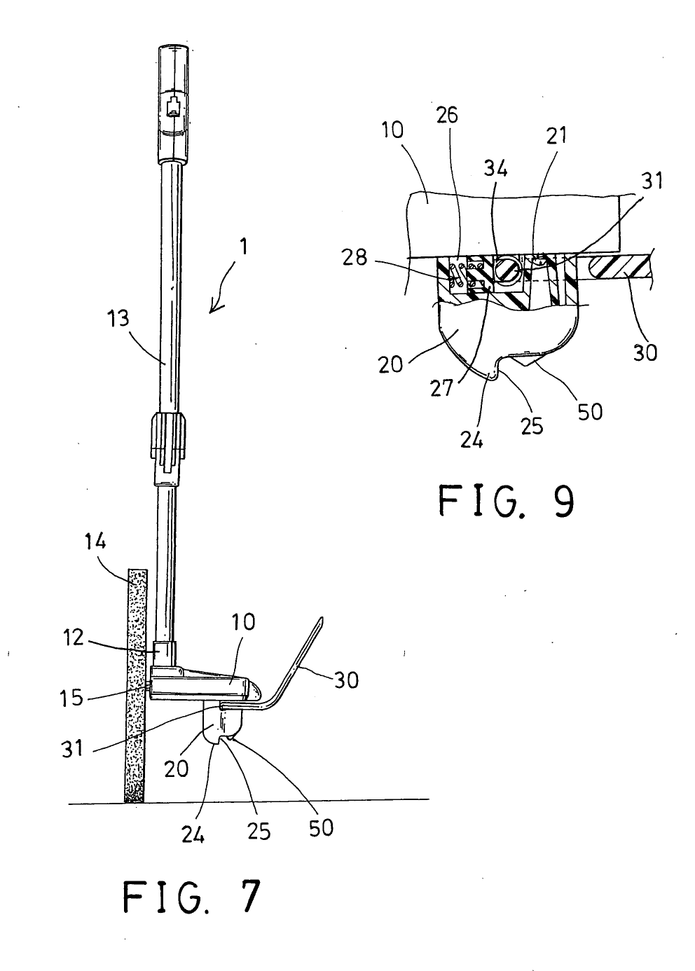

The casing 20 includes a protrusion 24 provided or extended downwardly from the bottom portion thereof, to form or define an anchoring shoulder 25 therein (FIGS. 2-4 and 6-9), for engaging with the anchoring edge 33 of the stand 30 (FIGS. 6 and 8), and for retaining and anchoring and positioning the stand 30 to the casing 20 and thus to the housing 10 at a downward working position (FIGS. 1, 6 and 8). It is preferable that the protrusion 24 is located closer to the measuring wheel 14, and the anchoring shoulder 25 of the casing 20 is facing away from the measuring wheel 14, for allowing the stand 30 to be rotated relative to the casing 20 and the housing 10 toward an upward non-working or storing position (FIG. 7).

The casing 20 further includes a compartment 26 formed or provided therein (FIGS. 3 and 8-9) for slidably receiving a presser or actuator 27 therein, and a spring member 28 received within the compartment 26 thereof and engaged with the actuator 27, for biasing and forcing the actuator 27 toward and to engage with the shaft 31 of the stand 30 (FIGS. 8 and 9), and for maintaining or positioning the stand 30 to the casing 20 and the housing 10 at either the downward working position or the upward non-working or storing position. For example, the stand 30 includes a cam member 34 formed on or attached or provided on the shaft 31 thereof, for engaging with the actuator 27, and for positioning the stand 30 to the casing 20 and the housing 10 at either the downward working position or the upward storing position, best shown in FIGS. 8 and 9.

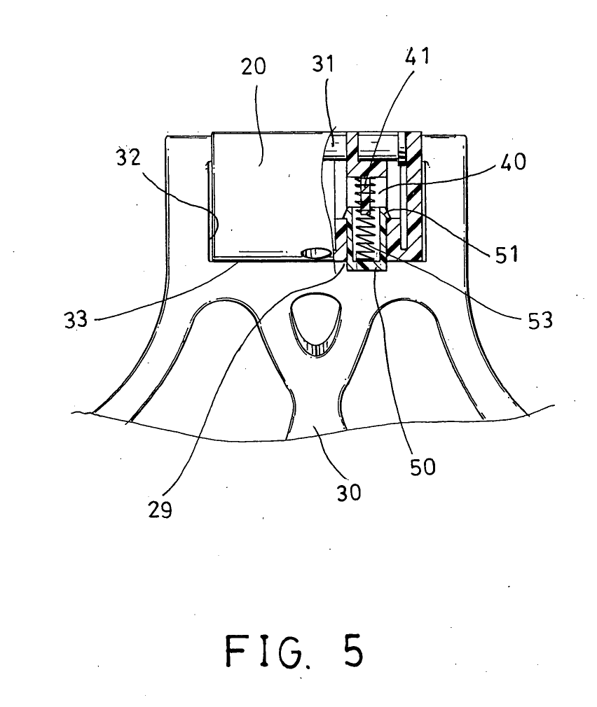

The casing 20 further includes a passage 29 formed or provided in the bottom portion thereof, best shown in FIGS. 4 and 5, for slidably receiving a latch 50,therein. The latch 50 includes one or more, such as two spring-biased catches 51 extended therefrom, for engaging into an interior 40 of the casing 20 (FIG. 5), and for selectively engaging with the casing 20, in order to limit the sliding movement of the latch 50 relative to the casing 20, and so as to prevent the latch 50 from being disengaged from or moved out of the casing 20. The latch 50 is slightly movable out of the casing 20 (FIGS. 5-9), for selectively engaging with the stand 30, so as to maintain or position the stand 30 to the casing 20 and the housing 10 at the downward working position (FIGS. 5-6 and 8).

A spring member 53 may further be provided and received within the interior 40 of the casing 20, and engaged with the latch 50, for biasing and forcing the latch 50 to move downwardly and outwardly of the casing 20 (FIG. 5), and thus for actuating the latch 50 to engage with the stand 30, and to maintain or position the stand 30 to the casing 20 and the housing 10 at the downward working position. It is preferable that the casing 20 includes a pin 41 formed or extended therein, such as extended into the interior 40 thereof (FIG. 5), for engaging with the spring member 53, and for stably positioning the spring member 53 in place or within the interior 40 of the casing 20.

In operation, when the stand 30 is rotated relative to the casing 20 and the housing 10 from the upward non-working or storing position toward the downward working position, the anchoring edge 33 of the stand 30 may be moved over the latch 50, to move or to force the latch 50 inwardly into the interior 40 of the casing 20, until the anchoring edge 33 of the stand 30 is engaged with the anchoring shoulder 25 of the casing 20. After the anchoring edge 33 of the stand 30 has been moved over the latch 50, the latch 50 may be biased by the spring member 53 to slightly moved out of the casing 20 again, and to engage with the stand 30, so as to maintain or position the stand 30 to the casing 20 and the housing 10 at the downward working position (FIGS. 6 and 8).

The presser or actuator 27 that is slidably received within the compartment 26 of the casing 20 and that is engaged with or biased by the spring member 28 may be biased and forced to engage with the shaft 31 or the cam 34 of the stand 30, in order to further stably maintain or position the stand 30 to the casing 20 and the housing 10 at either the downward working position or the upward non-working or storing position. The latch 50 is arranged to allow the latch 50 to be forced or moved inwardly into the interior 40 of the casing 20 against the spring member 53 by the anchoring edge 33 of the stand 30, and thus to allow the stand 30 to be rotated relative to the casing 20 and the housing 10 from the downward working position toward the upward non-working or storing position again.

Accordingly, the wheeled distance measuring device in accordance with the present invention includes a stand or kickstand that may be stably anchored or positioned thereto and that may be prevented from falling down inadvertently.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A wheeled distance measuring device comprising:
a housing,
a wheel rotatably attached to said housing for distance measuring purposes,
a casing secured to said housing, and including a protrusion extended therefrom, to form an anchoring shoulder therein, and
a stand including a shaft rotatably attached to said casing, and including an anchoring edge for engaging with said protrusion of said casing and for positioning said stand to said casing at a downward working position.

2. The wheeled distance measuring device as claimed in claim 1, wherein said casing includes a spring-biased latch received therein and extendible out therefrom, to selectively engage with said stand, and to further position said stand to said casing at the downward working position.

3. The wheeled distance measuring device as claimed in claim 2, wherein said latch includes at least one catch extended therefrom, for engaging into an interior of said casing, and for engaging with said casing, to limit a sliding movement of said latch relative to said casing, and to prevent said latch from being disengaged from said casing.

4. The wheeled distance measuring device as claimed in claim 2, wherein said casing includes a spring member disposed therein and engaged with said latch, for biasing and forcing said latch to move out of said casing and to engage with said stand.

5. The wheeled distance measuring device as claimed in claim 4, wherein said casing includes a pin extended therein and engaged with said spring member, for stably positioning said spring member in said casing.

6. The wheeled distance measuring device as claimed in claim 1, wherein said casing includes a channel formed therein for rotatably receiving said shaft of said stand, and for rotatably attaching said stand to said casing.

7. The wheeled distance measuring device as claimed in claim 1, wherein said casing includes an actuator biased to engage with said shaft of said stand, for selectively maintaining and positioning said stand to said casing at the downward working position.

8. The wheeled distance measuring device as claimed in claim 7, wherein said stand includes a cam member provided on said shaft thereof, for engaging with said actuator.

9. A wheeled distance measuring device comprising:
a housing,
a wheel rotatably attached to said housing for distance measuring purposes,
a casing secured to said housing,
a stand including a shaft rotatably attached to said casing, and including a cam member provided thereon, and
a spring-biased actuator received in said casing and biased to engage with said cam member of said stand, for maintaining and positioning said stand to said casing at a downward working position.

10. The wheeled distance measuring device as claimed in claim 9, wherein said casing includes a compartment formed therein for slidably receiving said actuator, and a spring member is received within said compartment of said casing and engaged with said actuator, for biasing and forcing said actuator to engage with said cam member of said stand.

11. The wheeled distance measuring device as claimed in claim 9, wherein said casing includes a protrusion extended therefrom, to form an anchoring shoulder therein, and to engaged with said stand, for further maintaining and positioning said stand to said casing at the downward working position.

12. The wheeled distance measuring device as claimed in claim 9, wherein said casing includes a spring-biased latch received therein and extendible out therefrom, to selectively engage with said stand, and to further position said stand to said casing at the downward working position.

13. The wheeled distance measuring device as claimed in claim 12, wherein said latch includes at least one catch extended therefrom, for engaging into an interior of said casing, and for engaging with said casing, to limit a sliding movement of said latch relative to said casing, and to prevent said latch from being disengaged from said casing.

14. The wheeled distance measuring device as claimed in claim 12, wherein said casing includes a spring member disposed therein and engaged with said latch, for biasing and forcing said latch to move out of said casing and to engage with said stand.

15. The wheeled distance measuring device as claimed in claim 14, wherein said casing includes a pin engaged with said spring member, for stably positioning said spring member in said casing.
